(19) United States
(12) Patent Application Publication
(10) Pub. No.: US 2024/0417159 A1
(43) Pub. Date: Dec. 19, 2024

(54) Cooking Apparatus and Method

(71) Applicant: Van Reginald Porter, JR., Gilbert, SC (US)

(72) Inventor: Van Reginald Porter, JR., Gilbert, SC (US)

(21) Appl. No.: 18/334,655

(22) Filed: Jun. 14, 2023

(51) Int. Cl. B65D 85/804; A23L 25/00

(52) U.S. Cl. CPC B65D 85/8067; A23L 25/20

(57) ABSTRACT

An apparatus and method for cooking food by providing a water permeable container, such as a mesh bag or pouch, that contains both food and spices, flavorings, and the like, and boiling the bag, along with its contents. In one particular example, the food is dry peanuts in the shell, and the spices and flavorings are formed into a densely packed mass, such as a ball or cube that is placed into the bag or pouch along with the peanuts. The densely packed flavoring mass (also referred to herein as a “spice ball”) may be formed from any desired spices, and may be formed using any desired method of production. The spice ball is preferably dense enough to sink in water so that it is “non-buoyant”, and preferably heavy and dense enough to aid in submerging the bag of peanuts to the bottom of a container of water during the boiling process.

### FIELD OF THE INVENTION

The present invention relates to an apparatus and method particularly suited for boiling food in a water permeable bag or pouch. More specifically, the present invention relates to an apparatus and method of packing food, such as dried peanuts, into a mesh bag or pouch, along with a densely packed mass of spices, flavorings and the like, and boiling the food within the mesh bag until the food is cooked properly.

### BACKGROUND OF THE INVENTION

Many commercially available food packages are designed to be easy to prepare, such as TV dinners, microwave meals and the like. It is desirable to provide food that is easy to prepare, and which does not require a lot of preparation time or effort to cook. One method of cooking that is generally simple to do is boiling food that has been pre-packaged for this purpose. For example, different types of rice are currently packaged in water-permeable packages designed to be dropped into boiling water for quick and easy preparation.

One issue with attempting to boil certain types of food is that certain foods to be buoyant, which requires longer boiling time, because the food (such as dry peanuts) must first become saturated before it will cook properly, and food that is floating on water, rather than being immersed in it, takes longer to become saturated, and ultimately causes time delays in cooking.

The following references disclose various attempts to provide food packaged in water-permeable containers to be cooked in boiling or hot water. The references listed below are hereby incorporated herein by reference, in their entireties:

UK Patent Publication No. GB2117350A—Boil in Bag Pouch

A boil-in-bag package for food products is manufactured from a single, overlapped web of a thermoplastic film to form a pillow-type pouch having transverse top 9, 10 and bottom 6,7 seals and two spaced-apart longitudinal seals 12, 13 which are positioned to seal both edges of the overlapped film. The extent of film overlap is at least 2.54 cm and the top and/or bottom ends of the pouch are provided with a horizontal aperture 8, 11 of at least 1.9 cm in length within the region of the film overlap.

WIPO Patent Publication No. WO2012059358A1—Cooking Methods for Simultaneously Cooking Foods

A method of preparing a food dish simultaneously cooking a food item with rice, wherein the food item is seasoned or flavoured by placing food and seasoning or flavouring ingredients inside a cook-in bag, sealing the cook-in bag, placing the sealed cook-in bag in a cooking appliance, and wherein the rice is placed in the cooking appliance either before or after the cook-in bag is placed in the cooking appliance, and the food item and the rice are cooked together. A cooking kit for use in the method comprising a cook-in bag provided together with a sachet containing seasoning or flavouring ingredients.

WIPO Patent Publication No. WO2000047484A1—Boil-In-Bag Package

A boil-in-bag package (10) for the storage and cooking of food items includes an elongated rectangular shaped bag (912) having an inside (14) and outside wall (16), a closed top end (18) and open bottom end (20). A handle section (24) is adjacent the top end of the bag section, with the handle section having an upper (26) and lower (28) portion and first (30) and second (32) side. The upper portion (26) of the handle section includes an opening sized and shaped for receiving a lifting utensil. A sealing/release mechanism (34) is positioned on the handle section (24) and is configured to releaseably close the open bottom end (20) of the elongated bag section contiguous with the handle section thereby forming a U-shaped package (12) configured to allow a through-flow of fluid between the inside walls (14) of the U-shaped package (12). The sealing/release mechanism (34) is further configured to allow for the release of the open bottom end (20) from the handle section (24) without contacting the elongated bag section.

US Patent Publication No. US20120328745A1—Boil-In Bag Pouch

A boil-in-bag pouch (1,50) containing a foodstuff (30), wherein said pouch is in the form of an enclosed body (4,52) having a front face (8,78), a back face (7,80), a top end, a bottom end, and first and second sides (9,10,54,56) extending between said lop and bottom ends, said pouch comprising: a single sheet of flexible sheet material having first and second opposed edges, wherein said sheet is folded along said first side (10,54) and said second side (9,56) to define said front and back faces, wherein opposed edges of said sheet are bonded by a longitudinal seal (2,70) extending from said top end to said bottom end of said pouch; a top transverse seal bonding said front and back faces together proximate to said top end; a bottom transverse seal bonding said front and back faces together proximate to said bottom end; and wherein said sheet is folded form a pleat extending from the bottom transverse seal to the top transverse seal along only one of said sides (10,54) of said body (4,52).

U.S. Pat. No. 10,440,979—Apparatus and Methods for at Least Semi-Autonomous Meal Storage and Cooking Via Fluid Immersion

A method of using a fluid-immersion storage and cooking device having a thermal container that defines a first volume and a second volume includes disposing a first food item in the first volume. A second food item and a third food item are disposed in the second volume in a first position and a second position, respectively. A volume of fluid having a first temperature is circulated through the first volume to transfer thermal energy to the first food item. After a predetermined time, at least a portion of the volume of fluid is heated to a second temperature. A portion of the volume of fluid is conveyed to the second volume such that (1) the second food item is substantially submerged in the portion of the volume of fluid and (2) the third food item is disposed substantially outside of the portion of the volume of fluid.

U.S. Pat. No. 6,342,258—Boil-In Bag Sachet

A boil-in-bag sachet is provided comprising top and bottom transverse seals, wherein the bottom transverse seal extends obliquely downwardly from at least one edge of the sachet that intersects an edge of the sachet at an angle of less than 90°, and preferably defining a bag-like or funnel-like bottom to the sachet, thereby improving drainage of water from within the sachet.

U.S. Pat. No. 6,153,232—Boil-In Bag Package

A boil-in-bag package for the storage and cooking of food items includes an elongated rectangular shaped bag having an inside and an outside wall, a closed top end and an open bottom end. A handle section is adjacent the top end of the bag section, with the handle section having an upper and a lower portion and a first and second side. The upper portion of the handle section includes an opening sized and shaped for receiving a lifting utensil. A sealing/release mechanism is positioned on the handle section and is configured to releaseably close the open bottom end of the elongated bag section contiguous with the handle section thereby forming a U-shaped package configured to allow a through-flow of fluid between the inside walls of the U-shaped package. The sealing/release mechanism is further configured to allow for the release of the open bottom end from the handle section without contacting the elongated bag section.

U.S. Pat. No. 5,914,142—Easy Opening Boil-In-a Bag Pouch

A boil-in-a-bag pouch provided with a handle for grasping and lifting the pouch and including a easy opening mechanism The opening of the pouch is facilitated by a longitudinal line of weakness spaced a short distance from one longitudinal edge of the pouch in combination with either a lateral cut from the edge of the pouch to the line of weakness or one or more interruptions in the lateral seals used to form and seal the pouch through which the line of weakness passes. The interruptions in the lateral seal are small enough to prevent egress of the product from the pouch and are located so as to permit the pouch to be torn open along the line of weakness through the interruptions in the lateral seals. In this manner, a pouch is provided that has both a handle and an easy opening feature.

U.S. Pat. No. 5,827,559—Cook in Packaging and Methods Relating Thereto

Heat sealable films for packaging food products, particularly in applications where the packaged food product is heated at high temperatures in a hot water bath. The films have a sealant layer containing an acid copolymer. The acid copolymer has a high degree of ethylene crystallinity and therefore an unusually high melting temperature. The sealant layer provides excellent seal strength and excellent adhesion to meat, particularly poultry, even during hot water immersion.

U.S. Pat. No. 5,328,705—Cooked Food Product Package

A meat product package including an enclosing film having an EVA-containing inside surface and an in situ aqueous medium-cooked meat product in adhering relation to the film inside surface as the meat contacting and adhering surface. Starch particles are preferably dispersed across the meat contacting surface which has been both irradiated and subjected to corona treatment. A method for corona treating a thermoplastic tube inside surface in which small particles within the flat tube separate opposite surfaces providing voids, and the electric discharge crosses the flat tube through the voids.

U.S. Pat. No. 3,819,089—Food Storage and Cooking Bag and Associated Holder and Dispensing Element

A food storage and cooking bag of conventional lay-flat tubular construction is heat sealed at one end to form a handle, V-shaped notches being formed immediately adjacent the handle along the opposite longitudinal edges of the bag. A tearable seal is formed at the opposite end of the bag to permit vacuum sealing of the contents of the bag and subsequent tearing open of that end of the bag for ease of removal of the contents. A bag holding and dispensing element includes a central portion having an elongated slot through which the upper, or handle, end of the bag is inserted for assembling the bag with the element, and a pair of arms formed integrally with the central portion and extending outwardly therefrom. The arms engage the upper edges of the side walls of a cooking vessel containing boiling water into which the food containing portion of the bag is immersed, the element maintaining the handle portion of the bag accessible for ease of removal thereof from the vessel when cooking is completed. Thereafter, the tearable seal is removed to open the end of the bag, the bag then being grasped by the handle and withdrawn through the slot of the element or, equivalently, the element being slid toward the open end of the bag, to extrude, or dispense, the contents of the bag for serving.

U.S. Pat. No. 3,615,712—Plastic Food Pouch for Cooking

A “‘cooking pouch’” for foodstuffs such as pasta (e.g. noodles, macaroni, spaghetti), rice, and the like is formed from two separate films, preferably made of heat-sealable plastic, which are sealed together at the edges. One of the films is perforated over a substantial portion of its area, while the other is substantially imperforate, except it may optionally contain a line of weakness such as a perforated line to facilitate opening, and is made of a clear, transparent material.

Each of the above-referenced inventions have certain disadvantages, particularly relating to food that tends to float on water, as that buoyant food tends to take longer to cook than food that is immersed in water. Thus, it would be desirable to provide an apparatus and method wherein buoyant food is placed into a bag with a densely packed mass that weighs down the water-permeable container so that the buoyant food is forced underwater for cooking purposes. Additionally, if such a densely packed mass were formed from spices, similarly to a bouillon cube or a salt lick, then the densely packed mass serves two purposes: 1) it helps to weigh down the water permeable container to sink the food, and 2) it slowly dissolves, providing flavoring to the food in during the boiling/cooking process.

### BRIEF SUMMARY OF THE INVENTION

The present invention relates to an apparatus and method for cooking food by providing a water-permeable container, such as a mesh bag or pouch, that contains both food and spices, flavorings, and the like, and boiling the bag, along with its contents. In one particular embodiment, the food is dry peanuts in the shell, and the spices and flavorings are formed into a densely packed mass, such as a ball or cube that is placed into the bag or pouch along with the peanuts. The densely packed flavoring mass (also referred to herein as a “spice ball”) may be formed from any desired spices, and may be formed using any desired method of production. The spice ball is preferably dense enough to sink in water so that it is “non-buoyant”, and preferably large enough to assist in submerging the bag of peanuts to the bottom of a container of water during the boiling process.

During the boiling process, the spice ball slowly disintegrates as the peanuts (or other type of food) becomes saturated, and the spices and flavorings are slowly imparted to the food to improve the taste. The spice balls may include spices that actually dissolve in water, such as salt, and may also include spices that do not dissolve, but still impart flavor to the water and food contained therein. As the peanuts become saturated, they also become less buoyant, and thus the need for the weight of the spice ball(s) to maintain the bag or pouch at the bottom of a pot of water decreases over time, as the spice ball dissolves. In this way, as the spice ball dissolves, the food becomes saturated enough so that the need for the weight of the spice ball diminishes until the spice ball is mostly or entirely dissolved, and the bag of food remains submerged within the container of boiling water.

It is contemplated that the bag of peanuts and the spice ball may be boiled in any suitable container, such as a pot or a crockpot, or it may be placed into a pressure cooker, which tends to shorten the time required for cooking.

### DESCRIPTION OF THE DRAWINGS

These and other features, aspects, and advantages of the present invention will become better understood with regard to the following description and accompanying drawings where:

FIG. 1 is a perspective view of one embodiment of a water permeable mesh bag containing dry peanuts in shells, along with a spice ball;

FIG. 2 is a perspective view of one embodiment of a water permeable mesh bag containing dry peanuts in shells and a spice ball, and a container of boiling water for boiling the peanuts and spice ball within the bag; and

FIG. 3 is a perspective view of one embodiment of a water permeable mesh bag containing dry peanuts in shells and a spice ball submerged in boiling water within a container, wherein the spice ball helps to sink the bag to the bottom of the container.

### DETAILED DESCRIPTION OF THE INVENTION

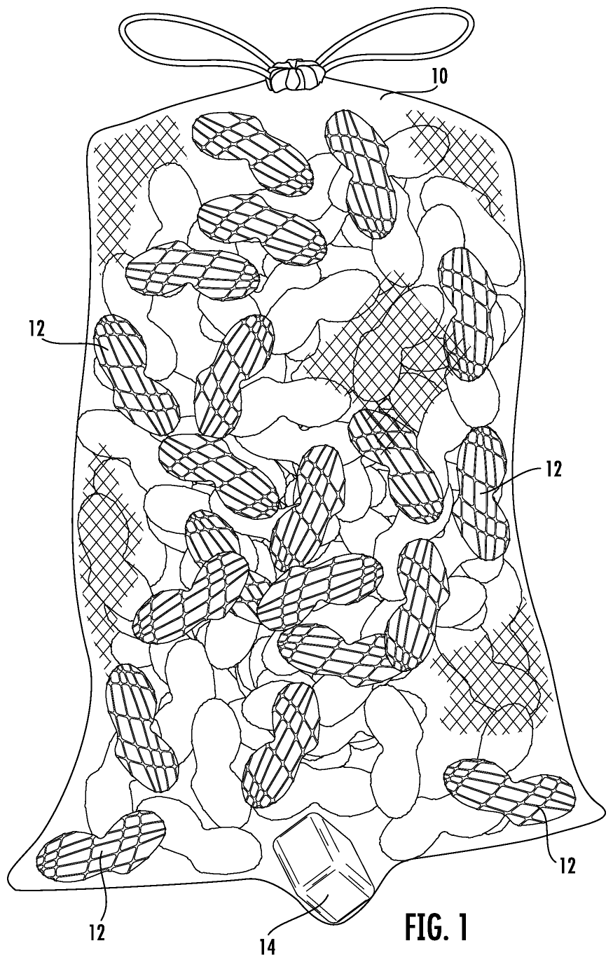

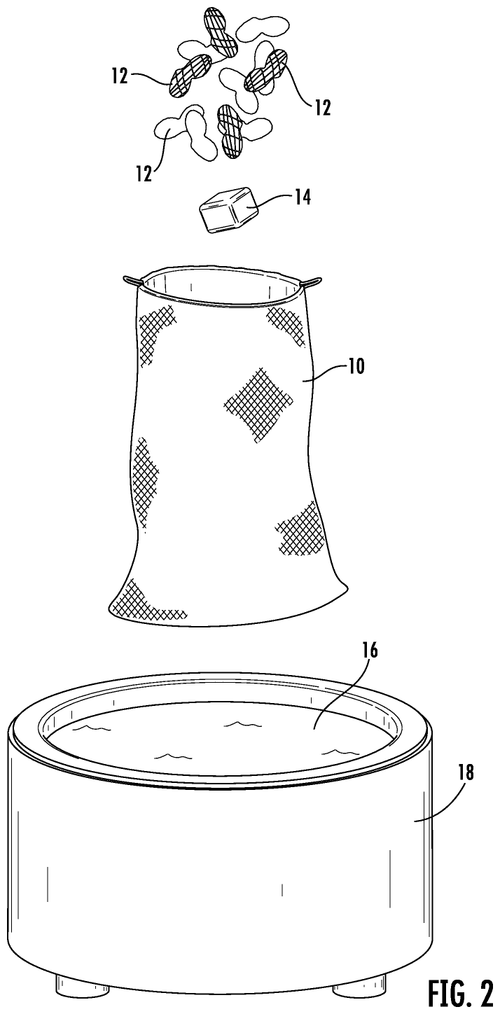

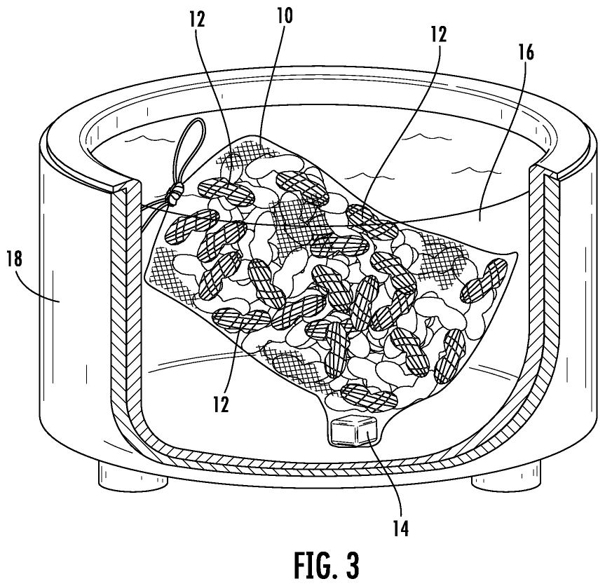

FIG. 1 illustrates an embodiment of the present invention whereby a water permeable container 10 (in this instance, a mesh bag) contains dry peanuts in shells 12, and further contains a densely packed spice ball 14 containing any desired spices and flavorings. The mesh bag 10 and its contents may be dropped into boiling water 16 to cook the peanuts 12, and the spice ball 14 serves to sink the bag 10 to the bottom of the container 18 of water 16, as shown in FIGS. 2 and 3. As the cooking process proceeds, the boiling water 16 saturates the peanuts 12, which are dry and buoyant to begin with, and the boiling water 16 also begins to disintegrate the spice ball 14. During this process, as the spice ball 14 disintegrates, the flavor from the spice ball 14 is disbursed throughout the boiling water 16 and the peanuts 12. In this way, as the process proceeds, the spice ball 14 slowly disintegrates as the peanuts 12 become more saturated with water 16 and less buoyant, so that at the end of the process, the peanuts 12 remain submerged without assistance, and the spice ball 14 dissolves or disintegrates.

The spice ball 14 may be formed in any desired manner, similarly to a salt lick or a bouillon cube. In some cases, binders may be used to bind the spices together. The spices may include any desired flavorings, including but not limited to salt, sugar, onion powder, ground pepper, red pepper flakes, garlic powder, cayenne pepper, and the like. Spice balls may be formed similarly to bouillon cubes or broth cubes, which are typically dehydrated broth or stock formed into a small cube or other cuboid shape, although any desired shape may be formed. The most common format is a cube about 13 mm (½ in) wide. It is typically made from dehydrated vegetables or meat stock, a small portion of fat, MSG, salt, and seasonings, shaped into a small cube. Vegetarian and vegan types are also made. Stock cubes are made by mixing already dry ingredients into a paste. The ingredients are usually mixed in a container (batch mixing), left to mature, and then shaped into the cube form. Alternatively, they can be mixed directly into an extruder.

It should be understood that the water permeable bag or pouch 10 may contain a single spice ball 14, or multiple spice balls 14. In a preferred embodiment, the weight and density of the spice ball 14 (or spice balls) should be high enough to assist in sinking the bag containing buoyant food, such as dry peanuts, to the bottom of a container of water.

In use, the bag with the peanuts 12 and spice ball(s) 14 is placed into a container 18, such as a pot, crock pot or pressure cooker, along with enough water 16 to submerge the bag 10 and its contents, and the water 16 is brought to a boil for several hours. Specific cooking procedures are set forth in the examples provided below:

### Items Needed

1 gallon water
Unopened water permeable mesh bag 10 containing dry peanuts 12 and spice ball 14
A slow cooker (Crock-pot), stock pot, or pressure cooker—(6-8 qt recommended)

### Example 1: Preparation (Slow Cooker or Stock Pot)

Add 1 gallon of water to pot 18 (enough for bag 10 to fully submerge once cooked)
Place unopened bag 10 in water
Cover and cook 2 hours (slow cooker on Hi, stock pot on Med-Hi)
Remove lid and flip bag 10 over (top to bottom)
Cover and cook (min. 8-10 hours for either method)
Reduce to Low and allow to soak for additional flavor and tenderness (2-4 hours . . . or longer)
Remove bag 10 from pot 18, Drain and Enjoy.

### Example 2: Preparation (Pressure Cooker)

Add water to “max fill” line of Pressure Cooker 18
Place unopened bag 10 of peanuts 12 and spice ball 14 in water 16.
Seal lid, set steam release to “Do Not Vent” and pressure cook on Hi for 4 hours
Allow pressure cooker to naturally depressurize (about 2-4 more hours)
Remove bag 10 from pot 18, Drain and Enjoy.

Although the water permeable container 10 described herein is generally described as a mesh bag or pouch, it is contemplated that other suitable types of water permeable containers may be used. The water permeable pouch or bag 10 may be manufactured using any suitable material, including polymeric materials, and may be sealed with the food and spice ball contained therein in any suitable manner. Additionally, other types of food may be used instead of dry peanuts 12, which were described herein by example, for illustrative purposes. Spice balls 14 may be formed in any suitable manner, using any desired spices, herbs or flavorings, and may be formed into any desired shape and size, but are preferably heavy enough and include a high enough density to sink the mesh bag or pouch 10 containing the buoyant foodstuff. It is also contemplated that other non-disintegrating weights may be used, if necessary, and the weights should be manufactured from an acceptable food grade material that will not contaminate or otherwise negatively affect the food or food quality within the water permeable pouch during the cooking process.

Further, it is contemplated that the present invention may be used without a spice ball, particularly with regard to dry peanuts 12, as the mesh bag itself also assists with keeping a significant percentage of the peanuts 12 submerged, even in the dry state. By containing all of the peanuts 12 within the mesh bag or pouch 10, many of the peanuts 12 at the bottom of the bag remain submerged, as the mesh bag 10 prevents the peanuts 12 from disbursing from one another and floating to the top of the water. As the cooking process progresses, the submerged peanuts 12 within the mesh bag 10 become saturated, which assists in sinking the mesh bag 10 to submerge all of the peanuts 12 over time.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A food package containing food to be boiled in water, said food package comprising:
a water permeable container; and
buoyant food disposed within said water permeable container.

2. The food package set forth in claim 1, further comprising a densely packed mass of spices and flavorings disposed within said water permeable container, wherein said densely packed mass of spices and flavorings is non-buoyant in water.

3. The food package set forth in claim 2, wherein said densely packed mass of spices and flavorings includes ingredients selected from the group consisting of salt, sugar, onion powder, ground pepper, red pepper flakes, garlic powder, and cayenne pepper.

4. The food package set forth in claim 1, wherein said water permeable container is formed from a polymeric material.

5. The food package set forth in claim 1, wherein said food is dry peanuts within shells.

6. A method of preparing food, comprising the steps of:
providing a water permeable container;
sealing buoyant food within said water permeable container, wherein said densely packed mass of spices and flavorings is non-buoyant in water;
placing said water permeable container including said buoyant food into a container of water;
boiling said water;
disintegrating said densely packed mass of spices and flavorings within said boiling water; and
removing said water permeable container and said food from said water.

7. The method set forth in claim 6, including the step of providing a densely packed mass of spices and flavorings within said water permeable container.

8. The method of preparing food set forth in claim 6, wherein said food is dry peanuts within shells.

9. The method of preparing food set forth in claim 7, wherein said densely packed mass of spices and flavorings includes ingredients selected from the group consisting of salt, sugar, onion powder, ground pepper, red pepper flakes, garlic powder, and cayenne pepper.

10. The method of preparing food set forth in claim 6, wherein said water permeable container is a mesh bag.

11. The method of preparing food set forth in claim 6, wherein said container of water is selected from the group consisting of a cooking pot, a slow cooker, and a pressure cooker.
